(19) United States
(12) Patent Application Publication
(10) Pub. No.: US 2015/0369481 A1
(43) Pub. Date: Dec. 24, 2015

(54) CHIMNEY PIPE, EXHAUST GAS SYSTEM AND METHOD FOR PRODUCING AN EXHAUST GAS SYSTEM HAVING SUCH A CHIMNEY PIPE

(71) Applicant: JEREMIAS GMBH FACHGROSSHANDEL FÜR SCHORNSTEINBEDARF, Wassertruedingen (DE)

(72) Inventor: Stefan ENGELHARDT, Muenchen (DE)

(21) Appl. No.: 14/839,049

(22) Filed: Aug. 28, 2015

Related U.S. Application Data
(63) Continuation of application No. PCT/EP2014/000526, filed on Feb. 28, 2014.

(30) Foreign Application Priority Data
Mar. 4, 2013 (DE) 202013002004.0

(51) Int. Cl. F23J 13/04; F16L 9/18; F16L 25/10; B23P 19/04

(52) U.S. Cl. CPC F23J 13/04; B23P 19/04; F16L 9/18; F16L 25/10; F23J 2213/20; F23J 2213/202

(57) ABSTRACT

In order to be able to make length adjustments in a chimney pipe system as flexibly as possible, the chimney pipe has two opposite connection ends, which are connected to each other by a center part. The one connection end has a conical insertion region and the other connection end is cylindrical. The cylindrical configuration enables arbitrary trimming on site, without additional measures being required.

### CROSS-REFERENCE TO RELATED APPLICATION

This is a continuation application, under 35 U.S.C. §120, of copending international application No. PCT/EP2014/000526, filed Feb. 28, 2014, which designated the United States; this application also claims the priority, under 35 U.S.C. §119, of German patent application No. DE 20 2013 002 004.0, filed Mar. 4, 2013; the prior applications are herewith incorporated by reference in their entirety.

### BACKGROUND OF THE INVENTION

### Field of the Invention

The invention concerns a chimney pipe, especially for a refined steel exhaust gas system with two opposite connection ends to form a plug-in connection with additional chimney pipes and with a middle piece between the connection ends. The invention furthermore concerns an exhaust gas system composed of such chimney pipes, especially a refined steel exhaust gas system, and a method for producing such an exhaust gas system.

In order to construct a metal exhaust gas system or smokestack, especially a refined steel exhaust gas system, for both interior and exterior application, several chimney pipes are usually inserted one into the other. There are both single-wall and double-wall designs for this. In the double-wall variant design, the chimney pipe has an inner pipe and an outer pipe, and between them is arranged an intermediate insulating layer. Double-wall exhaust gas systems are provided in particular for outside use.

Such exhaust gas systems can be found for example in German utility models DE 94 19 304 U1 and DE 295 22 176 U1 and published, non-prosecuted European patent application EP 0 798 513 A2. From the latter, a double-wall system is known.

In order to form tight connections between the individual chimney pipes, these each have plug-in sleeves at their ends, being typically conically expanding or conically tapering, respectively.

In order to be universally useful for different requirements, such exhaust gas systems are composed of several modular building blocks on the whole. Thus, typically chimney pipes of different length are kept in stock in order to make an exhaust gas system with a desired overall length.

### SUMMARY OF THE INVENTION

It is accordingly an object of the invention to provide a chimney pipe, an exhaust gas system and a method for producing an exhaust gas system having such a chimney pipe that overcome the above-mentioned disadvantages of the prior art devices and methods of this general type, which makes possible a flexible chimney pipe system.

The problem is solved as claimed in the invention by a chimney pipe, especially for a refined steel exhaust gas system, with two opposite connection ends to form a plug-in connection with other chimney pipes, and with a middle piece between the connection ends. Wherein the first, or lower connection end in the installed state forms a conical insertion region and the second opposite or upper connection end in the installed state is cylindrical in configuration.

Thanks to the conical configuration at only one end, a dependable gas-tight insertion connection is assured between two consecutive chimney pipes. Preferably, no further measures are required or provided for the gas-tight connection, other than the inserting of the chimney pipes one into the other. The conical connection end is shoved into the cylindrical connection end of a second chimney pipe. Thanks to the purely cylindrical configuration of the upper connection end, the special benefit is achieved that the chimney pipe itself can be shortened to a desired length without problems. At the same time, the full function is preserved, so that the particular chimney pipe can be trimmed exactly to the desired length directly on site at the construction site.

Thanks to the cylindrical configuration of the chimney pipe in the region of the second connection end, it can be shortened at this side without any further measures to produce a new cylindrical connection end. Therefore, the pipe end forms a new cylindrical connection end at the separation site with no further measures.

For this, it is advisable that the inner diameter of the cylindrical connection end be identical to the inner diameter of the middle piece. Therefore, the cylindrical connection end is flush with the middle piece.

In regard to a reliable, secure seal in the installed position of two interconnected chimney pipes, the cylindrical connection end is somewhat conically widened by the conical connection end. Therefore, the cylindrical connection end is fitted to the conical connection end. The latter therefore widens the cylindrical connection end when inserted into it in the manner of a die, so that the two connection ends lie tightly against each other.

In order to make possible an easy insertion of the conical connection end into the cylindrical connection end, the conical insert region preferably has a terminal, radially inward sloping insert bevel, which has a larger angle of inclination than the actual conical insert region.

In addition, in a preferred modification, an encircling groove is formed in the conical insert region, acting as a capillary barrier.

Again in addition, at least at one connection end there is formed an encircling bead which serves for the installing in particular of a clamping tape or also a fastening clip. The encircling bead directly adjoins the conical insert region, and preferably so. It is formed in the inner wall by a deformation, so that an encircling annular rib is formed on the outside.

Basically such a bead can and in a preferred embodiment also is formed in the region of the cylindrical connection end. If need be, furthermore, the possibility exists of cutting the chimney pipe to length at this cylindrical end. Thanks to the inner diameters being flush with each other, the function of the plug-in connection is independent of the arrangement of the encircling bead in the region of the cylindrical connection end.

Preferable, however, is a configuration in which no such encircling bead is provided in the cylindrical end region.

The cone angle of the conical insert region usually lies in the range of 0.5° to 3° and especially in the range of 1°. Furthermore, the conical insert region has an axial length in the range of 40 mm to 100 mm and lies typically at 75 mm, for example, for an inner pipe diameter of 150 mm, for example.

The configuration with the cylindrical connection end is preferably used for single-wall chimney pipes. In an alternative preferred embodiment, the chimney pipe is also fashioned as a double-wall chimney pipe with an inner pipe, an outer pipe, and an intermediate insulating layer.

In this configuration, preferably only the inner pipe is fashioned with the conical and the cylindrical connection ends. Thus, this configuration also enables a simplified interconnecting of double-wall chimney pipes and at the same time it enables a cutting of such double-wall chimney pipes to length as needed.

In order to make the plug-in connection, no intermediate insulating layer is formed between outer pipe and inner pipe in the conical insert region. For the interconnecting, the outer pipe in the region of the conical connection end is shoved across the coordinated outer pipe of the other chimney pipe at its cylindrical connection end. The conical insertion region is therefore inserted in the inner pipe at one end and the outer pipe is placed on the outside.

For an easy installation, the outer pipe is somewhat radially widened in the region of the conical connection end and has a correspondingly fashioned, radially outwardly widened bevel. Regardless of this bevel, the outer pipe is cylindrically shaped in the conical insert region of the inner pipe.

The problem is furthermore solved as claimed in the invention by an exhaust gas system, especially a refined steel exhaust gas system, and by a method for the production of such an exhaust gas system, with several such chimney pipes which are inserted one into the other.

The overall exhaust gas system is distinguished by easy cutting to length of the individual chimney pipes thanks to the purely cylindrical connection end. At the same time, a reliable seal is assured in the insert connection region. This occurs, in particular, solely by the conical-cylindrical fit, with a conical deformation of the cylindrical region occurring in particular during the installation.

Such an exhaust gas system can be used for both low pressure and excess pressure applications. If need be, additional sealing elements can be arranged in the insert connection region.

The advantages mentioned in regard to the chimney pipe and the preferred embodiments are also applicable accordingly to the exhaust gas system and the method.

Other features which are considered as characteristic for the invention are set forth in the appended claims.

Although the invention is illustrated and described herein as embodied in a chimney pipe, an exhaust gas system and a method for producing an exhaust gas system having such a chimney pipe, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, side view of a chimney pipe according to the invention;

FIG. 2 is an interrupted side view of two interconnected chimney pipes;

FIG. 3 is a magnified representation of an insert connection region between the two chimney pipes of FIG. 2;

FIGS. 4A-4D are side views of various embodiment variants of a single-wall chimney pipe;

FIGS. 5A-5D are magnified illustrations of regions designated by the circle in FIGS. 4A-4D;

FIGS. 6A-6D are side view of various embodiment variants of a double-wall chimney pipe; and

FIGS. 7A-7D are magnified illustrations of regions designated by the circle in FIG. 6A-6D.

### DETAILED DESCRIPTION OF THE INVENTION

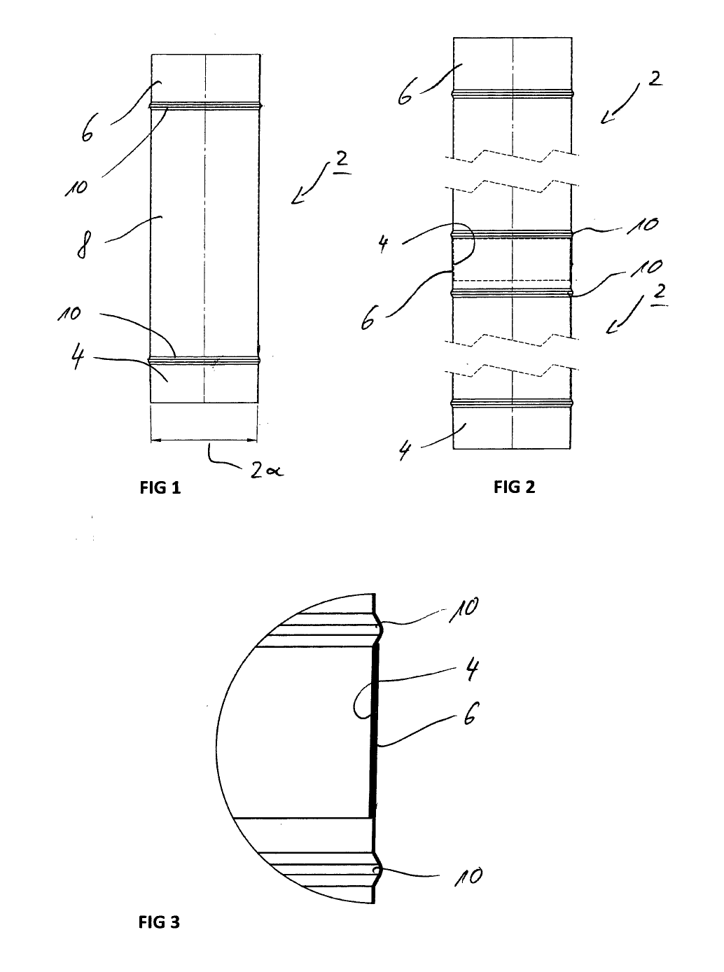

Referring now to the figures of the drawings in detail and first, particularly to FIG. 1 thereof, there is shown a chimney pipe 2 that extends in a longitudinal direction from a lower connection end with a conical insert region 4 to an upper cylindrical end 6. In between is arranged a middle piece 8, which is separated off at both ends 4, 8 by an encircling bead 10. The middle piece 8 here is strictly cylindrical in shape and is flush with the cylindrical connection end 6. Both partial regions therefore have the same (circular) cross section throughout, especially the inner cross section. The conical insert region 4 extends in the longitudinal direction from the end face of the chimney pipe 2 to the start of the lower bead 10. An axial length is typically in the range of around 75 mm.

The chimney pipe 2 has in the conical insert region a cone angle α which is 1 in the sample embodiment. FIG. 1 shows the double cone angle 2α.

As is especially evident from the magnified representations of FIG. 3, in the installed condition the cylindrical connection end 6 fits snugly on the outside against the conical insert region 4. The conical insert region 4 therefore widens the cylindrical connection end 6 somewhat, at least at the upper connection end. The inner diameter of the conical insert region 4 at its upper base region facing the bead 10, where the conical insert region 4 has the largest diameter, is preferably identical to the inner diameter of the middle piece and of the cylindrical connection end 6. The conical insert region 4 is therefore flush with the cylindrical middle piece 8. Thanks to this feature, the conical insert region 4 at its base region with the largest diameter has double the wall thickness of the chimney pipe's largest outer diameter as compared to the inner diameter of the cylindrical connection end 6, which results in the radial widening and conical fitting of the cylindrical connection region 6 in the final installed state. This ensures a reliable seal.

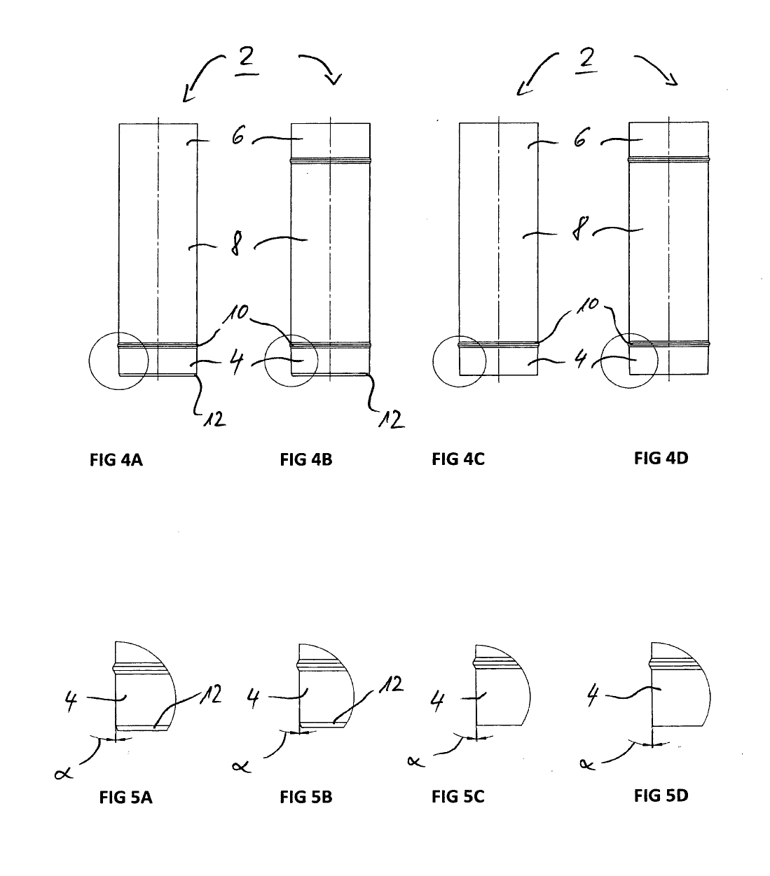

FIGS. 4A-4D as supplements to FIGS. 5A-5D show various embodiments of the single-wall chimney pipe 2. FIG. 4A with corresponding FIG. 5A shows a chimney pipe 2 which only has one bead 10 at the lower conical connection end 4. The end region opposite this is free of a bead 10. Therefore, the middle piece 8 passes identically into the cylindrical connection end 6. These are shown indistinguishable from each other.

Furthermore, one recognizes from the magnified representation of FIG. 5A that the conical insert region 4 has at its end face an insert bevel 12, which facilitates the inserting into the corresponding cylindrical connection end 6 of a coordinate chimney pipe 2.

FIG. 4B shows a variant embodiment in which an encircling bead 10 is also formed in the region of the cylindrical connection end 6. The two beads 10 are at least the same distance from the opposite end faces of the chimney pipe.

FIGS. 4C and 4D show comparable embodiments to FIGS. 4A and 4B, but here the conical insert region 4 runs out in a straight line to the end margin, and so has no insert bevel 12 at the end.

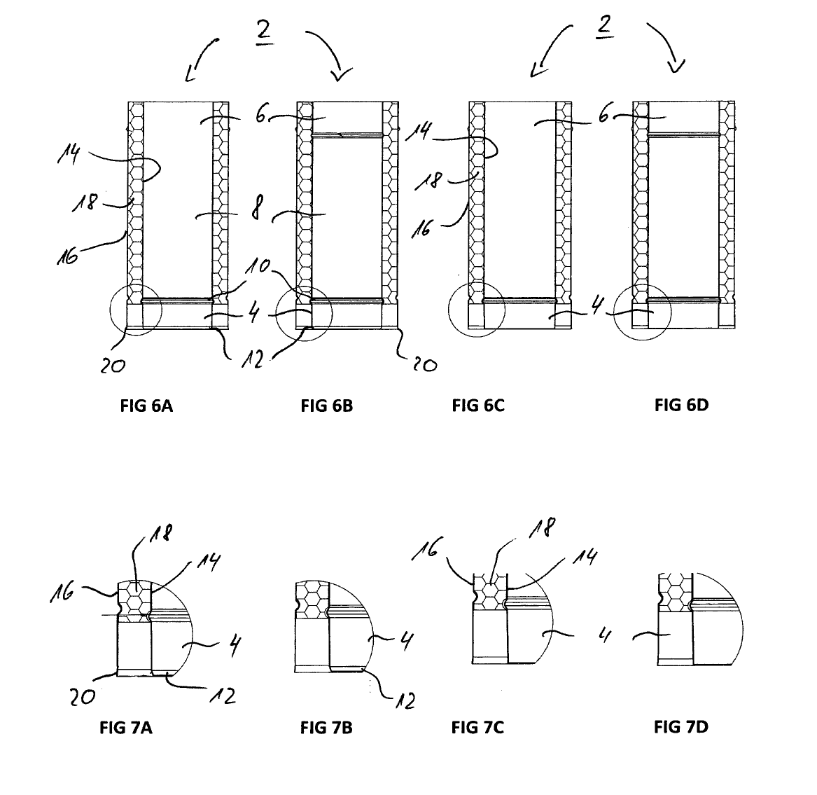

FIGS. 6A-6D show a double-wall embodiment of a chimney pipe 2, for example, for outdoor application. The respective chimney pipe 2 accordingly has an inner pipe 14, an outer pipe 16, and an intermediate insulating layer 18. The inner pipe 14 is configured in accordance with the chimney pipe 2 described for FIGS. 4A-4D. The chimney pipes 2 shown in FIGS. 4A-4D can therefore be used without any further changes as well for a double-wall embodiment.

As can be seen from FIGS. 6A-6D and especially also in combination with FIGS. 7A-7D, the intermediate insulating layer 18 is not continued in the conical insert region 4. Here, a free space is formed between the inner pipe 14 and the outer pipe 16. When two chimney pipes 2 are joined together, this is stretched over the opposite cylindrical connection end 6, so that the segment of the outer pipe 16 also grasps the cylindrical end of the coordinated outer pipe 16 on the outside and the conical insert region 4 of the inner pipe 14 in turn engages with the cylindrical connection end 6 of the coordinated inner pipe 14 on the inside. At the same time, the intermediate insulating layer 18 is continued without interruption as far as the upper end margin in the region of the cylindrical connection end 6. Both the outer pipe 16 and the inner pipe 14 are cylindrical throughout in the region of the cylindrical connection end 6 and in particular they are flush with a respective middle piece 8 of the inner pipe 14 as well as the outer pipe 16.

As is especially evident from the magnified representations of FIGS. 7A-7D, the outer pipe 16 has a radial widening as a kind of bevel 20 at the end face in the conical insert region 4. This facilitates the installation especially in combination with the radially inward bevel 12 on the inner pipe 14.

The following is a summary list of reference numerals and the corresponding structure used in the above description of the invention:
2 chimney pipe
4 conical insertion region
6 cylindrical connection end
8 middle piece
10 bead
12 insert bevel
14 inner pipe
16 outer pipe
18 intermediate insulating layer
10 bevel
α cone angle

1. A chimney pipe, comprising:
two opposite connection ends each forming a plug-in connection with additional chimney pipes, said two opposite connection ends including a first connection end having a conical insertion region and a second connection end being cylindrical in configuration in an initial state and that, for two interconnected chimney pipes, said second connection end, being a cylindrical connection end, of a first of the chimney pipes is conically widened by said conical insertion region of a second of the chimney pipes so that said two connection ends of the opposing chimney pipes lie tight against each other; and
a middle piece disposed between said two opposite connection ends.

2. The chimney pipe according to claim 1, wherein the chimney pipe can be cut to length at a side facing said cylindrical connection end and a pipe end at a separation site forms a new cylindrical connection end without any additional measures.

3. The chimney pipe according to claim 1, wherein said cylindrical connection end has an inner diameter identical to an inner diameter of said middle piece.

4. The chimney pipe according to claim 1, wherein said conical insertion region has a terminal, radially inward sloping insert bevel.

5. The chimney pipe according to claim 1, wherein said conical insertion region has an encircling groove formed therein as a capillary barrier.

6. The chimney pipe according to claim 1, wherein at least at one of said two opposite connection ends there is formed an encircling bead.

7. The chimney pipe according to claim 6, wherein no said encircling bead is formed in a region of said cylindrical connection end.

8. The chimney pipe according to claim 1, wherein a cone angle of said conical insertion region is in a range of 0.5° to 3° and said conical insertion region has an axial length in a range of 40 mm to 100 mm.

9. The chimney pipe according to claim 1, wherein the chimney pipe is configured as a double-wall chimney pipe with an inner pipe, an outer pipe, and an intermediate insulating layer.

10. The chimney pipe according to claim 9, wherein said inner pipe is configured with said conical insertion region functioning as a conical connection region.

11. The chimney pipe according to claim 9, wherein no said intermediate insulating layer is formed between said outer pipe and said inner pipe in said conical insertion region.

12. The chimney pipe according to claim 9, wherein said outer pipe has a radially outwardly widened bevel at an end in a region of said conical insertion region having a conical connection end.

13. The chimney pipe according to claim 1, wherein a cone angle of said conical insertion region is 1°.

14. The chimney pipe according to claim 1, wherein the chimney pipe is configured for use in a refined steel exhaust gas system.

15. An exhaust gas system, comprising:
a plurality of chimney pipes each containing two opposite connection ends to form a plug-in connection with each other, said two opposite connection ends include a first connection end having a conical insertion region and a second connection end being cylindrical in configuration in an initial state, said chimney pipes each further having a middle piece disposed between said two opposite connection ends, and for interconnecting two of said chimney pipes, said second connection end being a cylindrical connection end of a first of said chimney pipes, is conically widened by said conical insertion region of a second of said chimney pipes so that said two connection ends of opposing said chimney pipes lie tight against each other.

16. A method for producing an exhaust gas system, which comprises the steps of:
providing a plurality of chimney pipes each containing two opposite connection ends to form a plug-in connection with other ones of the chimney pipes, the two opposite connection ends including a first connection end having a conical insertion region and a second connection end being cylindrical in configuration, the chimney pipes each further having a middle piece disposed between the two opposite connection ends; and
inserting two of the chimney pipes into each other and in doing so the second connection end, being a cylindrical connection end, of a first of the chimney pipes is conically widened by the conical insertion region of a second of the chimney pipes so that the two opposing connection ends of the first and second chimney pipes lie tightly against each other.

17. The method according to claim 16, which further comprises:
cutting one of the chimney pipes to length at a side having the second connection end and by the cutting to length a new cylindrical second connection end is formed, which is joined by inserting with the conical insertion region of the first connection end of another one of the chimney pipes.
